(19) United States
(12) Patent Application Publication
(10) Pub. No.: US 2018/0281821 A1
(43) Pub. Date: Oct. 4, 2018

(54) AUTOMATIC POWER SAVER FOR A LOCOMOTIVE BATTERY

(71) Applicant: Progress Rail Locomotive Inc., LaGrange, IL (US)

(72) Inventors: Robert Spenk, Des Plaines, IL (US); Sajid Nanlawala, Chicago, IL (US)

(73) Assignee: Progress Rail Locomotive Inc., LaGrange, IL (US)

(21) Appl. No.: 15/473,298

(22) Filed: Mar. 29, 2017

(51) Int. Cl. B61C 17/06; H02J 7/00

(52) U.S. Cl. CPC B61C 17/06; H02J 7/0031; H02J 7/0047

(57) ABSTRACT

A power system for a locomotive includes a battery configured to provide electrical power to at least one component of the locomotive, an engine monitor for detecting whether an engine of the locomotive has been shut down, and an automatic power saver operatively associated with the battery. The automatic power saver includes a controller operatively associated with the engine monitor and configured to receive an input signal from the engine monitor, when the engine is shut down, and generate an output signal if the input signal is received. The automatic power saver includes a battery disconnect relay operably connecting the battery to the at least one component of the locomotive and automatically disconnecting the battery from the at least one component of the locomotive in response to expiration of a predetermined time period following receipt of the output signal from the controller.

### TECHNICAL FIELD

This disclosure generally relates to locomotives and, more particularly, relates to a device for disconnecting a locomotive battery to prevent battery drain.

### BACKGROUND

Locomotives are used on a daily basis around the world, to transport cargo and passengers along railways. Such locomotives may be powered by any power source or combinations of power sources, including, but not limited to, combustion engines (e.g., diesel engines), steam engines, and electrical battery power. Particularly, in some examples, locomotives may be powered by a combustion engine and a battery, wherein, for example, the engine is started using battery power. When a given trip of such a locomotive is completed, the locomotive typically is powered down until the next trip is undertaken. When doing so, the locomotive engineer typically moves a switch (often referred to as a “battery knife” and/or “knife switch”) to physically disconnect the battery from the locomotive's engine and electronics, in order to preserve life of the battery.

While effective, one downside to such an approach is that locomotive operators often fail to remember to manually pull the battery knife switch to disconnect the battery after a locomotive is parked and shut down. Generally, this will result in a drained (low power) or dead battery and, thus, prevents the locomotive from being able to subsequently start on its own battery power. In addition, a full discharge of the battery's power, as often occurs in such situations, can negatively affect the service life of the battery, particularly if full discharge occurs on multiple occasions.

Battery drain can be particularly troublesome in extreme weather conditions. In cold weather, for example, engines with low batteries will not start and, thus, may have to be idled overnight at a significant fuel cost to the operator. More specifically, such an approach raises operating costs in terms of replacement battery expense, fuel expense while idling, and/or lost downtimes while the locomotive is inoperable.

U.S. Pat. No. 6,928,972 Biess (“Biess”) discloses a system for providing auxiliary power to a large diesel engine, allowing shutdown of the engine in various weather conditions. An auxiliary power unit disclosed in Biess comprises a secondary engine coupled to an electrical generator. An automatic control system shuts down the primary engine after a period of idling, and the auxiliary power unit provides electrical power for heating and air conditioning. The auxiliary power unit automatically starts in response to a low coolant temperature, low battery voltage, and low air reservoir pressure. It may also start automatically after extended shutdown to ensure reliability.

However, the systems disclosed by Biess do not address issues with battery drain, due to accidental connection of a battery, to an electrical load, when battery power is not required. Accordingly, systems and methods for automatic battery disconnect, in such scenarios where battery power is not required, are desired. The present disclosure is directed to solving one or more of the issues discussed above and those contained in the prior art.

### SUMMARY

In accordance with one aspect of the present disclosure, a power system for a locomotive is disclosed. The power system may include a battery configured to provide electrical power to at least one component of the locomotive, an engine monitor for detecting whether an engine of the locomotive has been shut down, and an automatic power saver operatively associated with the battery. The automatic power saver may include a controller operatively associated with the engine monitor and configured to receive an input signal from the engine monitor, when the engine is shut down, and generate an output signal if the input signal is received. The automatic power saver may further include a battery disconnect relay operably connecting the battery to the at least one component of the locomotive and automatically disconnecting the battery from the at least one component of the locomotive in response to expiration of a predetermined time period following receipt of the output signal from the controller.

In accordance with another aspect of the present disclosure, a method for disconnecting a locomotive battery from a locomotive is disclosed. The method may include determining a state of the engine, the engine including an off state and an on state, determining whether an automatic power saver is enabled, starting a timer if the engine is in the off state and the automatic power saver is not enabled, disconnecting the battery from the power unit when the timer reaches a predetermined time interval.

In accordance with another aspect of the present disclosure, a locomotive is disclosed. The locomotive including an engine, a battery, configured to provide electrical power to, at least, the engine, a battery knife between the engine and the battery, the battery knife having a closed position and an open position, an engine monitor for detecting a state of the engine, the engine including an off state and an on state, and an automatic power saver. The automatic power saver may include a controller operatively associated with the engine monitor and configured to receive an input signal from the engine monitor, when the engine is shut down, and generate an output signal if the input signal is received. The automatic power saver may further include a battery disconnect relay operably connecting the battery to the at least one component of the locomotive and automatically disconnecting the battery from the at least one component of the locomotive in response to expiration of a predetermined time period following receipt of the output signal from the controller.

These and other aspects and features of the present disclosure will be more readily understood when read in conjunction with the accompanying drawings.

### BRIEF DESCRIPTION

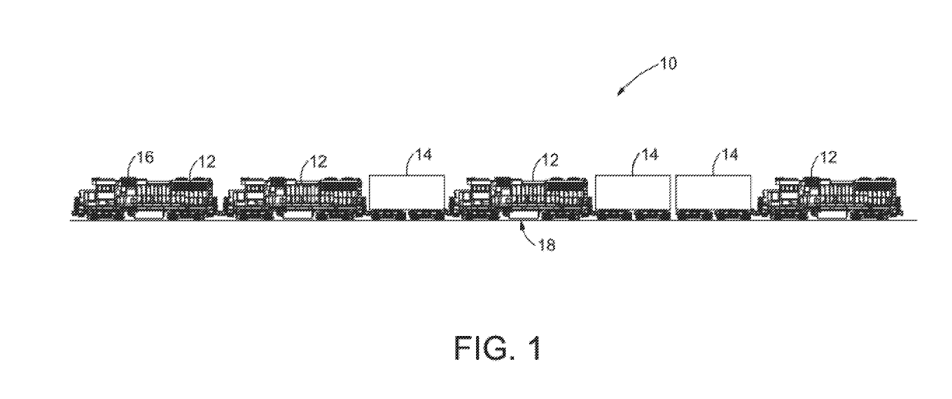

FIG. 1 is a side view of an exemplary train, in accordance with the present disclosure.

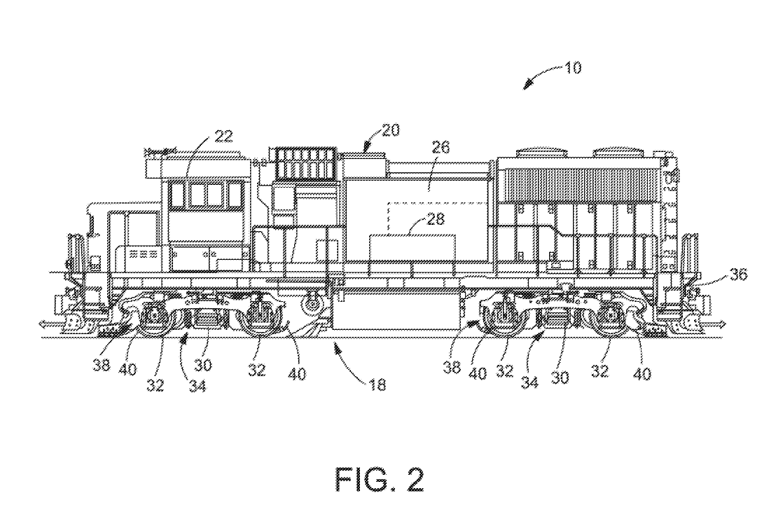

FIG. 2 is a side view of a locomotive of the train of FIG.1, in accordance with the present disclosure.

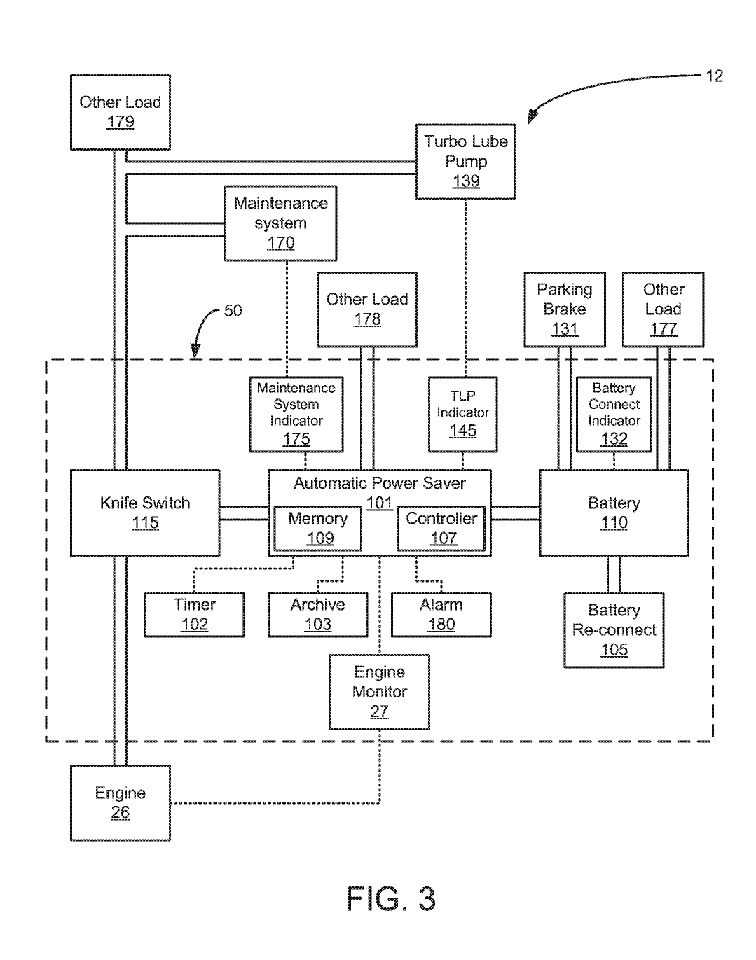

FIG. 3 is a representative block diagram of components of the train and an associated power system, in accordance with an embodiment of the disclosure.

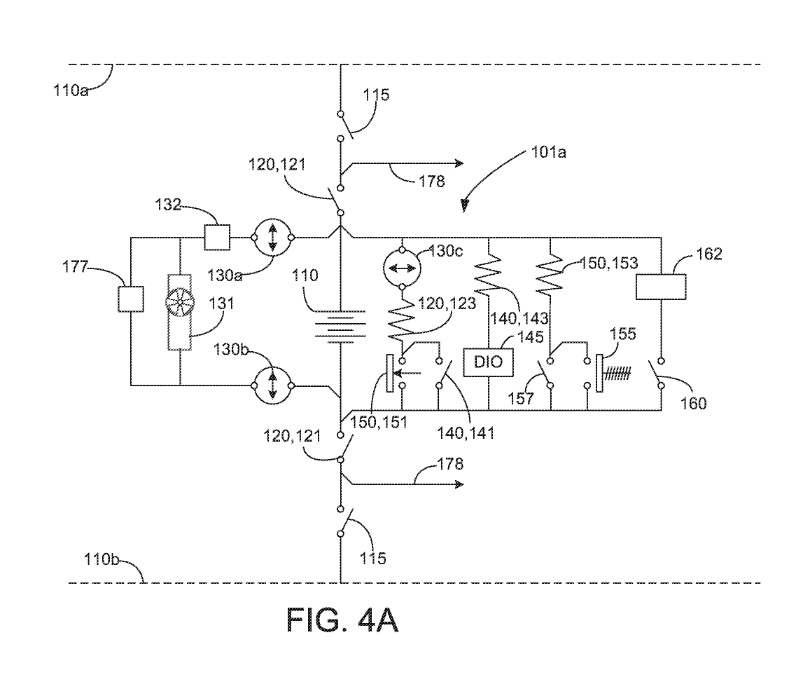

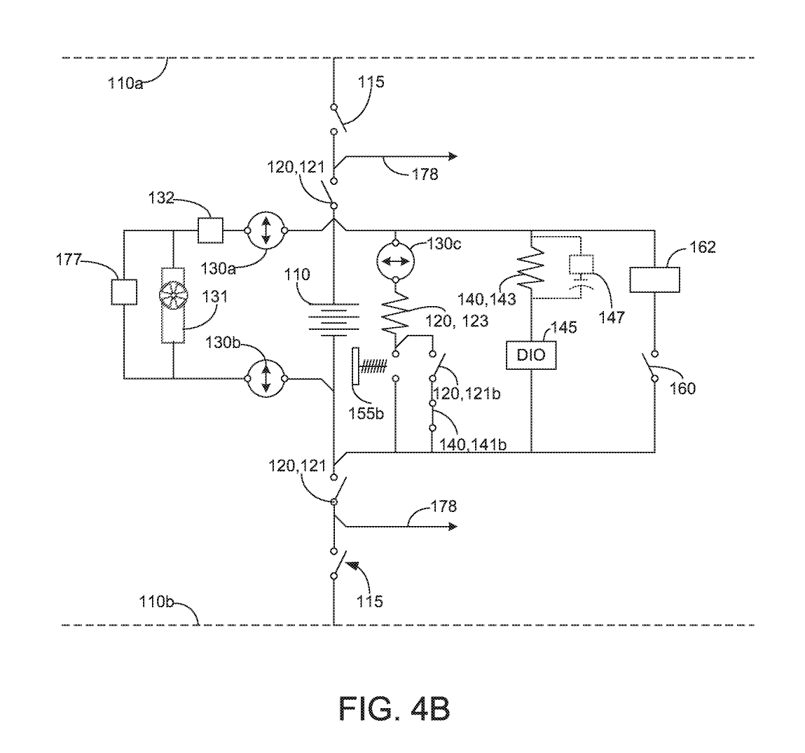

FIG. 4A is an electronic schematic diagram of components the train, the power system, and an automatic power saver of FIGS. 1-3, in accordance with an embodiment of the present disclosure.

FIG. 4B is an alternative electronic schematic diagram of components of the train, the power system, and the automatic power saver of FIGS. 1-3, in accordance with an embodiment of the present disclosure.

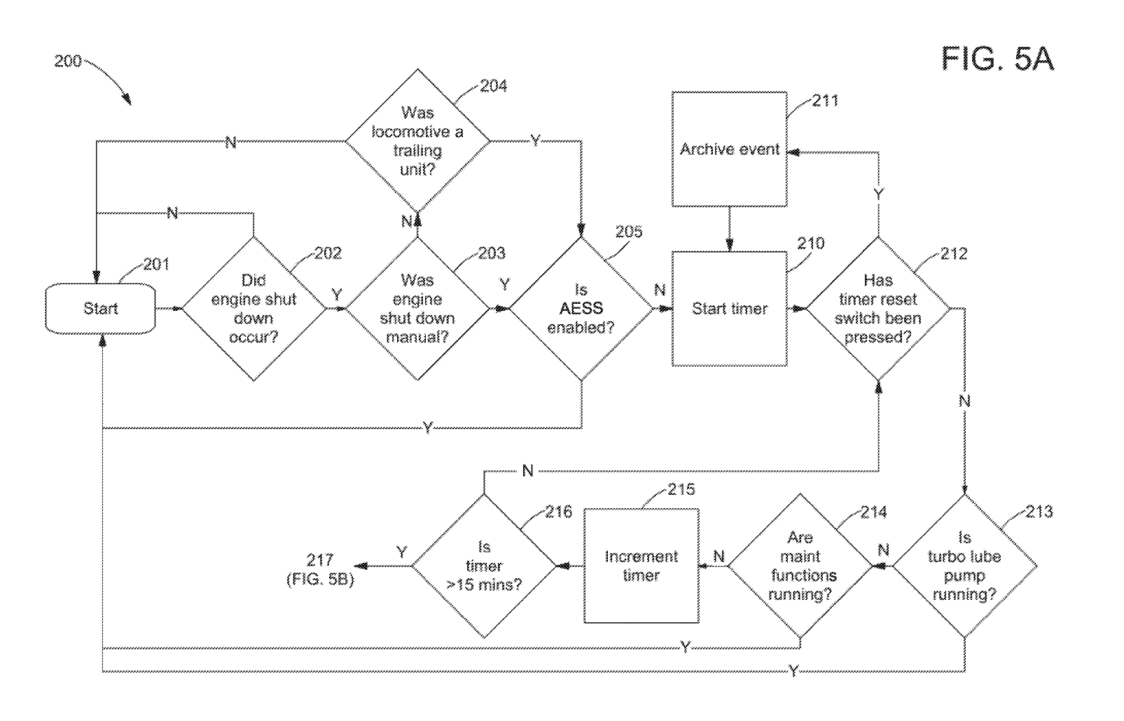

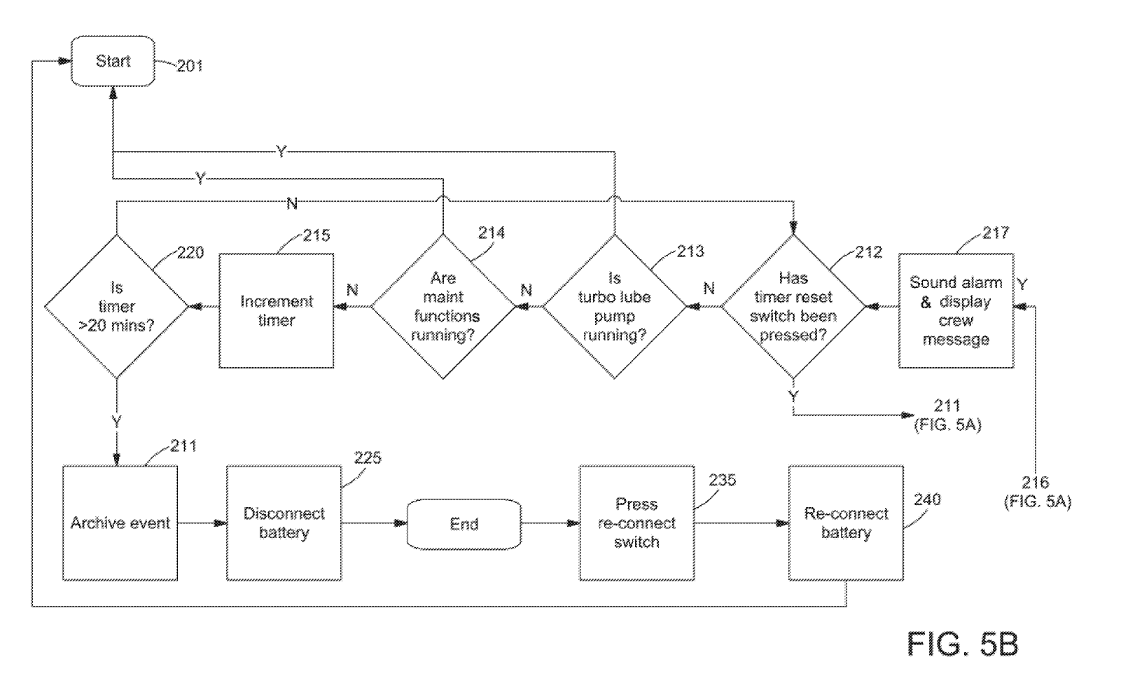

FIG. 5A is a flowchart of a method for selectively disconnecting a battery, in accordance with an embodiment of the present disclosure.

FIG. 5B is a continuation of the flowchart of FIG. 5A, in accordance with the embodiment of FIG. 5A and the present disclosure.

### DETAILED DESCRIPTION OF THE DISCLOSURE

Referring now to the drawings and with specific reference to FIG. 1, an exemplary train 10 is shown. The train 10 may include one or more locomotives 12 coupled with one or more railcars 14. In some example configurations, the one or more locomotives 12 may include a lead locomotive 16, at the front of the train 10, and the train 10 may be configured such that the lead locomotive 16 is coupled with other locomotives 12 and the one or more railcars 14. As a result, control commands made in the lead locomotive 16 may be transmitted directly or indirectly to the other locomotives 12 and the railcars 14. Trains, such as the train 10, which include one or more locomotives communicatively coupled with one or more railcars and configured to propel the train 10 down a track 18, may be referred to as a consist.

Turning now to FIG. 2 and with continued reference to FIG. 1, an example locomotive 12, including a car body 20, is illustrated. The car body 20 may include an operator cabin 22, wherein an operator 24 may control operations of the locomotive 12 and/or the train 10 at large. The locomotive 12 may include an engine 26 coupled with a generator 28, or other power source, located on the locomotive 12. The engine 26 may be a diesel, steam, gas turbine, electric, hybrid-electric, or any other known type of engine capable of generating electricity for the locomotive 12. The generator 28 may be driven by the engine 26 in order to produce electricity that is used to propel the locomotive 12, and any associated railcars 14, along the track 18. For example, the electricity produced by the generator 28 may be used by one or more traction motors 30 that are configured to drive one or more wheels 32 attached to the locomotive 12.

The generator 28 may also provide electricity for other systems, such as control systems, status systems or any other system that consumes electricity during the operation of the train 10. The traction motors 30 and wheels 32 may be coupled to the locomotive 12 using a chassis or subassembly often referred to as a bogie 34 or truck. In some embodiments, the locomotive 12 may have a plurality of bogies 34, each configured with a traction motor 30 and two sets of wheels 32; however, other configurations are possible. Moreover, the bogies 34 may include other components such as brakes, axles (not shown) or any other components associated with the bogies 34. The bogies 34 may be attached to a locomotive frame 36 and the frame 36 may be further configured to support the car body 20, the engine 26, the generator 28 and any other locomotive 12 components associated with the locomotive 12. A braking system 38 may be provided, including one or more braking devices 40. The one or more braking devices 40 may each be associated with one or all wheels 32 of a particular bogie 34. Control over wheel braking and engine fueling (as well as other locomotive controls) may be performed using one or more devices found within the operator cabin 22.

Turning to FIG. 3, a schematic diagram illustrating some components of the locomotive 12 and a power system 50, of the locomotive 12, is shown. As discussed above, with respect to FIG. 2, the locomotive 12 includes the engine 26 and, in some examples, the engine 26 may be operatively associated with an engine monitor 27, which is capable of communicating various statuses of the engine 26 to other components of the locomotive 12, such as, but not limited to, an automatic power saver 101 of the power system 50 and/or a controller 107 operatively associated with the automatic power saver 101. The engine monitor 27 may be configured to detect whether the engine 26 of the locomotive 12 has been shut down and, if the engine monitor 27 detects that the engine 26 has been shut down, generate an input signal to transmit to the automatic power saver 101.

In addition to the automatic power saver 101, the power system 50 includes a battery 110 and a knife switch 115. The battery 110 may be any battery or power source known in the art capable of providing electrical power to any load of the locomotive 12 or any loads associated with the locomotive 12. For the purposes of the block diagram illustrated in FIG. 3, dotted lines indicate a communicative relationship or connection amongst components of the locomotive 12 and/or associated power system 50 that includes transmission of some control command, signal, and/or data, whereas the solid, double lines connecting elements indicates a flow or transmission of electrical power from the battery 110 to one or more electrical load bearing components of the locomotive 12.

Accordingly, one or both of the automatic power saver 101 and the knife switch 115 may act as a switch providing or restricting electrical power transmission to such load components of the locomotive 12. Therefore, double lines connecting load components directly to the battery 110 indicate that electrical power is transmitted from the battery 110 directly to such load elements, barring any additional switches inserted between the battery 110 and said load components (e.g., a parking brake 131). Double lines connecting load components to the automatic power saver 101 indicate that such load components (e.g., the other load 178) receive power transmission from the battery 110, however, such transmission is switched on or off, in accordance with operation of the automatic power saver 101. Further still, double lines connecting load components to the knife switch 114 indicate that such load components (e.g., the engine 26, a maintenance system 170, a turbo lube pump 139), receive power transmission from the battery 110, however, such transmission is switched on or off, in accordance with operation of the automatic power saver 101, and can further be switched on or off in accordance with positioning of the knife switch 115.

By virtue of its placement within the power transition path between the battery 110 and certain load components (e.g., the engine 26), the knife switch 115 may allow for a user to manually disconnect a battery 110 without having to rely on the operation of the automatic power saver 101, which should operate to automatically disconnect the battery 110 under a specified set of circumstances, as discussed in more detail below. The knife switch 115 may be any electrical switching component, system, device, and/or apparatus configured to connect the battery 110 to the locomotive 12 in its closed state, but disconnect the battery 110 if in its open state. Such circumstances will be defined by the user and the technical specifications of a machine (e.g., the locomotive 12) that is equipped with the automatic power saver 101.

To that end, the automatic power saver 101 may operate by disconnecting the battery 110 from the locomotive 12, in addition to, optionally, selectively keeping certain load components connected to the battery 110 that an operator, and/or other actor associated with the locomotive 12, may want to keep powered. In some examples, the automatic power saver 101 may be operatively associated with, may execute instructions for, and/or may include a timer 102 (which may include or be associated with a timer reset switch), a system archive 103 for storing data on the operations of the locomotive 12 and/or power system 50, and various monitoring mechanisms to detect whether the battery 110 needs to be disconnected. To that end, the automatic power saver 101 may be operatively associated with and/or may include a controller 107 and/or a memory 109.

One or more operations of the automatic power saver 101 may be executed by the controller 107 and, additionally or alternatively, one or more operations of the automatic power saver 101 may be accomplished via physical components, as discussed in more detail below with respect to FIGS. 4A and 4B. To that end, operations of the automatic power saver 101 may be executed using any combination of computer-based elements (e.g., the controller 107), electrical component elements (e.g., the components discussed below with respect to FIGS. 4A and 4B), and/or any additional or alternative systems, methods, and/or apparatus for executing the disclosed operations of the automatic power saver 101 that may be contemplated by those having ordinary skill in the art.

The controller 107 may be any electronic controller or computing system, including a processor, which operates to perform operations, execute control algorithms, store data, retrieve data, gather data, and/or any other computing or controlling task desired. The controller 107 may be a single controller or may include more than one controller disposed to control various functions and/or features of the operator automatic power saver 101, the power system 50 and/or the locomotive 12. Functionality of the controller 107 may be implemented in hardware and/or software and may rely on one or more data maps relating to the operation of the operator automatic power saver 101, the power system 50 and/or the locomotive 12. To that end, the controller 107 may include or be otherwise operatively associated with the memory 109, which may include internal memory, and/or the controller 107 may be otherwise connected to external memory, such as a database or server. The memory 109 and/or external memory may include, but are not limited to including, one or more of read only memory (ROM), random access memory (RAM), a portable memory, and the like. Such memory media are examples of nontransitory memory media.

In operation, the automatic power saver 101 typically will not disconnect the battery 110 from any electrical load components of the locomotive 12, unless the engine 26 is no longer in operation. Accordingly, the automatic power saver 101 may prevent disconnection when the locomotive 12 (or other machine equipped with the automatic power saver 101) is still in operation.

In some examples, the locomotive 12 may include one or more of the turbo lube pump 139, the automatic locomotive maintenance or diagnostics system 170, and any additional other systems or components that operate either automatically or operate upon activation by an operator of the locomotive 12, once the primary engine 26 is not in operation. In examples wherein the locomotive 12 includes the turbo lube pump 139, the power system 50 may include a turbo lube pump indicator 162, which is configured to monitor the turbo lube pump 139 and indicate, to one or both of the automatic power saver 101 and/or an operator of the locomotive 12, whether or not the turbo lube pump 139 is in presently in operation. In examples wherein the locomotive 12 includes the automatic locomotive maintenance or diagnostics system 170, the automatic power saver 101 may include a maintenance system indicator 175, which may be configured to indicate, to one or both of the automatic power saver 101 and/or an operator of the locomotive 12, whether or not the automatic locomotive maintenance or diagnostics system 170 is presently in operation.

In operation, components such as engine 26, the parking brake 131, the turbo lube pump 139, the maintenance system 170, and/or any additional load components 177, 178, 179 may be dependent on battery 110 as a power supply and/or any of such components may rely on the battery 110 to start an associated auxiliary power source, and, thus, the automatic power saver 101 may refrain from disconnecting the battery 110, if one or more of these systems are in operation. Further, the archive 103 may track events associated with the power system 50 and/or the automatic power saver 101, to create an electronic record for monitoring performance of the locomotive 12 and/or to determine, retrospectively, why the battery 110 may have been drained. The power system 50 may also include a battery reconnection switch 105 which may be embodied by or include any switch that allows a user to manually reconnect the battery 110, when the battery 110 is disconnected.

Further, the power system 50 may include an alarm 180, which may be any system or apparatus capable of providing an alarm signal to any operator or actor associated with the locomotive 12, such alarm signals may include, but are not limited to including, audio, visual, and/or tactile alarm signals. In some examples, the alarm 180 will transmit such an alarm signal, prior to the automatic power saver 101 automatically disconnecting the battery 110, such that an operator, engineer, maintenance worker, and/or other actor in the vicinity of the locomotive 12 is given an opportunity to prevent automatic disconnection of the battery 110. Such prevention of shutoff may be accomplished by utilizing, for example, an automatic shutoff delay button and/or switch. In some examples, the power system 50 may, further, monitor a charge level of the battery 110. In such examples, the power system 50 may sound or display a separate alarm if the battery 110 is approaching a low charge, prompting an operator of the locomotive 12 to open the battery knife switch 115, disconnecting the battery 110 from the load components that are within the power transmission signal path of the knife switch 115, and preventing further battery draining.

Referring now to FIG. 4A, a schematic circuit diagram for an exemplary automatic power saver 101a, for use in conjunction with the power system 50 of FIG. 3, is shown. The circuit diagram for the automatic power saver 101a is depicted in FIG. 4A in conjunction with schematic representations for the battery 110 and the knife switch 115. The battery 110 creates a positive terminal 110a and a negative terminal 110b and is connected to the knife switch 115. A switch 121 of a battery disconnect relay 120 may be included, as part of the automatic power saver 101a, to break the circuit between the positive terminal 110a and negative terminal 110b in the event that knife switch 115 is not pulled. Accordingly, the battery disconnect relay 120 may disconnect the battery 110 from external electronic components when the switch 121 is opened. Thus, the battery disconnect relay 120 may act as a failsafe for preventing unwanted discharge of the battery 110, by automatically disconnecting battery 110 under certain, predetermined conditions, as discussed in more detail below. The knife switch 115 may be situated, within the power transmission path of the battery 110 to certain load components, between the switch 121 and the positive 110a or negative 110b terminals.

As shown, the automatic power saver 101a may be configured with any number of failsafe or independent connections to load components, which allow such elements to either influence whether or not the switch 121 opens. The illustrated configuration and power transmission paths of any of FIGS. 3, 4A, and/or 4B are certainly not limiting and any elements of the locomotive 12 may be powered independent of a switching status (“on” or “off”) of the battery disconnect relay 120 and/or independent of a switching status of the knife switch 115. Accordingly, circuit elements to the left of the battery 110 (e.g., the parking brake 131, the other load 177) represent elements that have a power transmission path that is independent of the switching status of the battery disconnect relay 120 and the switching status of the knife switch 115. Therefore, the parking brake 131 and the optionally included other load 177 may remain powered by the battery 110, regardless of the switching status of either the knife switch 115 and the battery disconnect relay 120. In some examples, the automatic power saver 101a may include one or more maintenance quick-disconnect switches 130, positioned such that a maintenance worker for the locomotive 12 can quickly disconnect all load components (e.g., the parking brake 131) from the battery 110. For example, the maintenance quick-disconnect switches 130a, 130b may be manually switched to disconnect all loads, including the parking brake 131 and other load 177 from the battery 110.

In some examples, the automatic power saver 101a may include a battery connect indicator 132, which may operate independent of the switching status of either the knife switch 115 and the battery disconnect relay 120, to indicate whether or not the battery 110 is connected to one or more load components or, generally, is present and providing electrical power. In such examples, the battery connect indicator 132 may be a light source (e.g., an LED) which is configured to indicated to an operator, maintenance worker, or other actor associated with the locomotive 12, whether or not the battery 110 is connected and/or operational.

Looking now to the elements of the automatic power saver 101a that are to the right of the battery 110, the automatic power saver 101a includes the battery disconnect relay 120 and may additionally include other relays or associated elements. The battery disconnect relay 120 may operate the switch(es) 121 based on charging of a coil 123 of the battery disconnect relay 120. As the switches 121 are normally open switches, when the coil 123 is charged, by virtue of its connection to the battery 110, then the switches 121 will be closed. Therefore, when the battery 110 is to be connected to all load elements, the coil 123 should be energized and, when it is desired that the switches 121 are to be opened, the coil 123 should be de-energized. In some examples, a maintenance quick disconnect switch 130c may be included in the power transmission path between the battery 110 and the coil 123.

In operation of the non-limiting example of FIG. 4A, the coil 123 may be energized or de-energized based on various conditions associated with the locomotive 12 and logically determined or detected by circuit elements and/or relays of the automatic power saver 101a. An automatic power saver relay 140 may be included, which includes a coil 143 and corresponding switch 141, which is a normally open switch. When the coil 143 of the automatic power saver relay 140 is energized, the switch 141 is closed, which causes the coil 123 of the battery disconnect relay 120 to receive power from the battery 110. The coil 143 of the automatic power saver relay 140 may be connected to the battery 110, based on the on or off status of a digital input/output device (DIO) 145. The DIO 145 may, effectively, act as a binary on or off switch between a de-energized coil 143 and an energized coil 143, based on any method, algorithm, or logic controlling switching of the DIO 145. Accordingly, the DIO 145 may receive instructions from, for example, the controller 107 and such instructions may, at least in part, be based on the logical method for controlling the automatic power saver 101 detailed, below, with reference to FIGS. 5A and 5B.

In some examples, the automatic power saver 101a may include additional features and/or elements to further control switching of the switches 121 of the battery disconnect relay 120, independent of or in addition to control of switching based on status of the automatic power saver relay 140. The automatic power saver 101a may include a delay timer relay 150, which includes a coil 153 and timed switch 151, while also being functionally associated with an input switch 155 and a fuel pump relay switch 157. When the coil 153 of the delay timer relay 150 is energized, the timed switch 151 is instructed to close for a set delay period of time, which may be any suitable period of time in which to delay disconnecting the battery 110 (e.g. 20 minutes). Therefore, if the delay timer relay 150 is energized, even if the automatic power saver relay 140 opens its switch 141, the coil 123 of the battery disconnect relay 120 will remain energized for the set delay period of time, as the switch 151 will prevent the coil 123 from de-energizing due to the open switch 141. Accordingly, the delay timer relay 150 may be utilized to override the logic controlling the DIO 145, to keep load components connected to the battery 110 for the set delay period of time

Energizing or de-energizing of the coil 153 and, thus, delaying de-energizing of the coil 123 of the battery disconnect relay 120, may be controlled based on one or both of the fuel pump relay switch 157 and the input switch 155. The fuel pump relay switch 157 may control the delay timer relay 150 by closing when the engine 26 of the locomotive 12 is engaged, thus charging the coil 153 and closing the timed switch 151. Additionally or alternatively, the delay timer relay 150 may be controlled via the input switch 155, which may close in response to input from an actor associated with the locomotive 12. For example, the input switch 155 may be a button or any other manual input based switch.

In some examples, the automatic power saver 101a may further include a turbo lube pump relay switch 160, which is configured to close when the turbo lube pump 139 of the locomotive 12 is operating. In some such examples, the automatic power saver 101a includes the turbo lube pump indicator 162, which indicates whether or not the turbo lube pump 139 is presently operating. In such examples, the turbo lube pump indicator 162 may be a light source (e.g., an LED) which is configured to indicate to an operator, maintenance worker, or other actor associated with the locomotive 12, whether or not the turbo lube pump 139 is in operation.

Turning now to FIG. 4B, but with continued reference to like elements of FIG. 4A and their respective detailed descriptions, above, an alternative schematic diagram for an automatic power saver 101b is illustrated. Like elements include the same numbering and, accordingly, provide the same or similar functions in the context of the automatic power saver 101b.

In contrast to the automatic power saver 101a of FIG. 4A, the automatic power saver 101b of FIG. 4B does not include the delay timer relay 150. However, similar functionality is still achieved, via the arrangement of elements in the circuit of the automatic power saver 101b and/or additional or alternative elements used therein. Accordingly, the automatic power saver 101b includes an RC circuit 147, connected in parallel with the coil 143, configured to delay disconnect of the battery 110. A switch 141b of the automatic power saver relay 140 may be a normally closed switch, which is configured to open when the coil 143 is energized. When the switch 141b is opened, the coil 143 may be de-energized, thus opening the switches 121, 121b of the battery disconnect relay 120. Because the switch 121b is a normally open switch in series with the normally closed switch 141b, an input switch 155b, which closes upon input, keeping the power transmission to the coil 123 and, thus, ensuring the switches 121 are closed, independent of action from the automatic power saver relay 140.

Of course, the automatic power saver 101a of FIG. 4A and the automatic power saver 101b of FIG. 4B are merely exemplary and additional or alternative circuit, logic, or computer based elements may be utilized to embody the automatic power saver 101.

### INDUSTRIAL APPLICABILITY

In general, the teachings of the present disclosure may find applicability in many industries including, but not limited to locomotives, construction, and excavation vehicles. More specifically, the present disclosure may find applicability in any industry where battery drain, following the shutdown of a fuel-powered (diesel, gasoline, etc.), hybrid-electric, and/or fully electric engine, is a concern. To that end, utilizing power systems, trains, and/or power switching methods that include an automatic power saver, such as the automatic power saver 101 discussed above, may result in lessening or eliminating unwanted power drain, from such a battery, when a locomotive, or other machine utilizing an automatic power saver, is not in use. Therefore, utilization of the systems, apparatus, and methods, disclosed herein, may lengthen the working life of components of such machines and/or may prevent machine downtime and, thus, increase industrial efficiency, due to prevention of battery drain.

Referring now to FIGS. 5A and 5B, a flowchart for an example method 200 of selectively disconnecting a battery is shown. The method 200 is described, below, with reference to elements of the locomotive 12, the power system 50, and/or the automatic power saver 101, as described in detail, above, with reference to FIGS. 1-4. However, the method 200 is certainly not limited to application in conjunction with the locomotive 12, the power system 50, and/or the automatic power saver 101 and the method 200 is capable of being performed utilizing additional or alternative machines and/or systems.

Beginning at start block 201, the method 200 monitors whether the engine 26 of the locomotive 12, which is connected to battery 110, has been shut down, as determined at decision block 202. Such determination may be made by, for example, the engine monitor 27 in conjunction with the controller 107. If the engine 26 is running, the method 200 returns to the start block 201. In examples wherein the engine 26 has shut down, the method 200 continues by inquiring whether shutdown was manual, as shown at decision block 203. If not, the method 200 continues to inquire whether the locomotive 12 was a trailing unit, as shown at decision block 204. If either conditions of decision blocks 204 or 203 are met the system inquires whether the automatic power saver 101 (APS, as referenced in FIG. 5) is enabled (e.g., the switches 121 are opened), as shown at decision block 205; if both are answered no, the method 200 returns to the start block 201. If the automatic power saver 101 is not enabled (e.g., the switches 121 are closed), a timer is started, as shown in block 210; if it is enabled the method 200 returns to the start block 201.

Once the timer is started at block 210, an archive 211 will record instances where a timer reset switch is pressed, as shown 212, or if the timer ever exceeds the battery disconnect threshold 220 (may be twenty (20) minutes). At decision block 212 it may be determined if a timer reset switch has been pressed and, at block 211, instances where a time reset switch is pressed may be recorded in an archive (e.g., the archive 103). Further, as depicted in FIG. 5B, if the timer ever exceeds the battery disconnect threshold (decision block 220), then such an instance is also recorded in the archive used at block 211. Accordingly, once the timer is activated as at 210, if the timer reset switch has been pushed (block 212), the timer is then reset, at block 210, after archiving the event at block 211.

Otherwise, the system proceeds to decision block 213, wherein the method 200 inquires if the turbo lube pump 139 is running; if the turbo lube pump 139 is running, the method 200 returns to the start block 201. If the turbo lube pump 139 is not running, the method 200 inquires whether the system maintenance functions are running (e.g., by the locomotive maintenance or diagnostics system 170) as shown at decision block 214; if such functions are in operation, the method 200 returns to the start block 201. If the system maintenance functions are not running, the timer will increment, as shown at block 215. The method 200 then determines if the timer's value is greater than a predetermined alarm value, as shown at decision block 216. If it is less than the alarm value, the system returns to block 212 to inquire whether the timer has been reset. If the timer exceeds the predetermined alarm value (e.g., fifteen minutes), as determined at decision block 216, an alarm may sound and/or a message may be displayed, as shown at block 217. The alarm can indicate to the locomotive engineer (or other user) that the battery 110 will be disconnected, unless the user resets the timer (e.g., by activating the reset switch described in reference to block 212). If the timer reset is pressed, the event is archived, as shown at block 211.

If the switch is not pressed, the method 200 will then proceed to re-inquire if the turbo lube pump 139 is running, as shown at block 213; if yes the system returns to the start block 201. If the turbo lube pump 139 is not running, the method 200 re-inquires whether the system maintenance functions are running, as shown at block 214; if yes the system returns to the start block 201. If the system maintenance functions are not running the timer will increment, as shown at block 215

The method 200 then determines if the timer's value exceeds a predetermined battery disconnect threshold (e.g., twenty minutes), as shown at decision block 220. If the timer's value is less than the battery disconnect threshold, the system returns to decision block 212 to inquire whether the timer has been reset. If the timer exceeds the battery disconnect threshold at decision block 220, then the method 200 continues to archive the event at block 211, then the battery 110 may be disconnected, as depicted at block 225, thus disconnecting, at least, the engine 26 of the locomotive 12 from the battery 110 and preventing battery drain due to unnecessary connection to the battery 110. Of course, other elements of the locomotive 12 (e.g., the parking brake 131) may remain connected to the battery 110, regardless of the actions of the method 200. Further, to re-connect the battery 110, a user may activate a reconnect switch, as shown at block 235, which causes the battery 110 to re-connect, as shown at block 240, and the method 200 may then resume functions at start block 201.

The above description is meant to be representative only, and thus modifications may be made to the embodiments described herein without departing from the scope of the disclosure.

Thus, these modifications fall within the scope of present disclosure and are intended to fall within the appended claims.

What is claimed is:

1. A power system for a locomotive comprising:
a battery configured to provide electrical power to at least one component of the locomotive;
an engine monitor for detecting whether an engine of the locomotive has been shut down; and
an automatic power saver operatively associated with the battery, the automatic power saver including
a controller operatively associated with the engine monitor and configured to receive an input signal from the engine monitor, when the engine is shut down, and generate an output signal if the input signal is received, and
a battery disconnect relay, the battery disconnect relay operably connecting the battery to the at least one component of the locomotive and disconnecting the battery from the at least one component of the locomotive, in response to expiration of a predetermined time period following receipt of the output signal from the controller.

2. The power system of claim 1, further comprising a knife switch located in a power transmission path between the engine and the battery, the knife switch having a closed position and an open position and capable of being manually switched amongst the closed and open positions.

3. The power system of claim 2, wherein the locomotive further includes a first load which is connected to the battery and receives electrical power from the battery, the first load remaining connected to the battery regardless of a switching status of one or both of the knife switch and the automatic power saver.

4. The power system of claim 3, wherein the first load includes, at least, a parking brake of the locomotive.

5. The power system of claim 1, wherein the locomotive includes one or more of a turbo lube pump, a locomotive maintenance or diagnostics system, and any combinations thereof.

6. The power system of claim 5, wherein operation of the battery disconnect relay is based, at least in part, on an operating status of one or more of the turbo lube pump, the locomotive maintenance or diagnostics system, and any combinations thereof

7. The power system of claim 1, wherein the battery disconnect relay includes, at least, a coil and a switch, the switch being configured to close in response to the coil being charged by the battery.

8. A method for selectively disconnecting a locomotive battery from a locomotive, the locomotive including an engine, the method comprising:
determining a state of the engine, the engine including an off state and an on state;
determining whether a switch of an automatic power saver is enabled;
starting a timer if the engine is in the off state and the automatic power saver is not enabled; and
disconnecting the battery from the power unit when the timer reaches a predetermined time interval.

9. The method of claim 8, further comprising:
determining whether a user-operated timer reset has been activated; and
resetting the timer if the user operated timer reset has been activated.

10. The method of claim 8, further comprising:
determining a state of a turbo lube pump of the locomotive, the turbo lube pump including an off state and an on state;
resetting and temporarily pausing the timer if the turbo lube pump is in the on state.

11. The method of claim 8, further comprising:
determining whether a locomotive maintenance system is in operation;
resetting and temporarily pausing the timer if the maintenance system is in operation.

12. The method of claim 8, further comprising activating an alarm when the timer reaches a second predetermined time interval, the second predetermined time interval being shorter than the predetermined time interval.

13. The method of claim 12, wherein the second predetermined time interval is fifteen minutes.

14. The method of claim 8, wherein the predetermined time interval is 20 minutes.

15. A locomotive, the locomotive comprising:
an engine;
a battery configured to provide electrical power to, at least, the engine;
a battery knife between the engine and the battery, the battery knife having a closed position and an open position;
an engine monitor for detecting a state of the engine, the engine including an off state and an on state;
an automatic power saver operatively associated with the battery, the automatic power saver including
a controller operatively associated with the engine monitor and configured to receive an input signal from the engine monitor when the engine is shut down and generate an output signal if the input signal is received, and
a battery disconnect relay, the battery disconnect relay operably connecting a battery to at least one component of the locomotive, the battery disconnect relay automatically disconnecting the battery from the at least one component of the locomotive in response to expiration of a predetermined time period following receipt of the output signal from the controller.

16. The locomotive of claim 15, further comprising a timer reset switch, wherein when the timer reset switch is activated the predetermined period of time is extended.

17. The locomotive of claim 15, wherein the controller monitors a set of conditions of the locomotive and selectively extends the predetermined period of time in response to detection of a condition, the condition selected from the group consisting of:
(i) operation of a locomotive turbo lube pump;
(ii) operation of locomotive maintenance functions; and
(iii) operation of a locomotive automatic engine stop start system.

18. The locomotive of claim 17, further comprising an alarm for alerting a user prior to disconnecting the battery from the engine.

19. The locomotive of claim 17, further comprising a system archive, the system archive automatically creating an electronic record when the predetermined period of time is extended.

20. The locomotive of claim 17, further comprising a manual battery reconnect capable of reconnecting the battery to the locomotive in response to a user's input.
